(19) United States
(12) Patent Application Publication
(10) Pub. No.: US 2017/0043935 A1
(43) Pub. Date: Feb. 16, 2017

(54) Automatically Reconfigurable Microwave Interactive Material

(71) Applicant: Graphic Packaging International, Inc., Atlanta, GA (US)

(72) Inventors: Fermin P. Resurreccion, JR., Thornton, CO (US); Vladimir C. Martinez, Aurora, CO (US)

(21) Appl. No.: 15/235,181

(22) Filed: Aug. 12, 2016

Related U.S. Application Data
(60) Provisional application No. 62/282,901, filed on Aug. 14, 2015.

(51) Int. Cl. B65D 81/34; A23L 5/30; H05B 6/64

(52) U.S. Cl. CPC B65D 81/3446; H05B 6/6408; A23L 5/34; B65D 2581/3489; A23V 2002/00

(57) ABSTRACT

Packaging material includes microwave interactive material and is automatically reconfigurable for selectively controlling transmission of microwave energy through the packaging material. The packaging material is configured to vary, as a function of time, a ratio of microwave energy transmitted through the packaging material. The packaging material is configured so that the microwave energy is automatically selectively transmitted in different ratios.

### CROSS REFERENCE TO RELATED APPLICATION

This application claims the benefit of U.S. Provisional Patent Application No. 62/282,901, filed Aug. 14, 2015.

### INCORPORATION BY REFERENCE

The disclosure of U.S. Provisional Patent Application No. 62/282,901, which was filed Aug. 14, 2015, is hereby incorporated by reference for all purposes as if presented herein in its entirety.

### BACKGROUND

Microwave ovens provide a convenient means for heating a variety of foods. It is common for the food being heated to be contained by a package including a pattern of microwave energy interactive material. During microwave heating, the microwave energy interactive material can affect how food is exposed to evanescent microwave energy and propagating microwave energy, for example as disclosed in U.S. Pat. No. 6,259,079.

### SUMMARY

An aspect of this disclosure is the provision of packaging material that includes microwave interactive material and is automatically reconfigurable for selectively controlling transmission of microwave energy through the packaging material. For example, the packaging material may be configured to vary, as a function of time, a ratio of microwave energy that is transmitted through the packaging material. In an embodiment of this disclosure, the packaging material is configured so that microwave energy is automatically selectively transmitted in different ratios.

Regarding the ratio between the evanescent microwave energy and transmitted microwave energy, the packaging material may be used to increase the ratio of the evanescent microwave energy that is exposed to food associated with the packaging material. For example, the food may be at least partially contained by a package comprising the packaging material. Increasing the ratio of the microwave heating that is caused by the evanescent microwave energy seeks to increase the browning and/or crisping of the exterior of the food item because, for example, as compared to the transmitted microwave energy, the evanescent microwave energy typically cannot propagate as far into the food. The packaging material may be configured so that, during the microwave heating of food, the food may be heated by substantially only evanescent microwave energy at the start of the microwave heating process, and the food may also be heated by the transmitted microwave energy toward the end of the microwave heating process.

The automatically reconfigurable microwave interactive material may be configured to reflect microwave energy, and such microwave energy interactive material may be referred to as shielding microwave interactive material (“shield material”). In an embodiment of this disclosure, the packaging material is configured so that the shield material is automatically reconfigurable (“reconfigurable shield”) from a first, relatively more effective shielding configuration (“less transmissive configuration”) to a subsequent, second, or less effective shielding configuration (“more transmissive configuration”) in response to exposure to microwave energy and/or inflation of one or more closed cells defined in the packaging material.

In an embodiment, numerous closed cells may inflate in response to the packaging material being exposed to a predetermined amount of microwave energy, and the transition of the reconfigurable shield from the less transmissive configuration to the more transmissive configurations may be responsive to inflation of the closed cells. As an example for each closed cell, inflation of the closed cell may cause relative movement between elements of the reconfigurable shield, so that at least one gap defined between the elements is widened. Widening of such gaps between such elements of the reconfigurable shield may cause the reconfigurable shield to become configured in its more transmissive configuration, so that its shielding effectiveness is reduced.

In the embodiment illustrated hereinbelow, in the less transmissive configuration of the reconfigurable shield, the grid is sized to not allow evanescent microwave energy to pass through the shield. In other embodiments, microwave energy can be transmitted through the reconfigurable shield. In contrast, in the more transmissive configuration of the reconfigurable shield, the transmitted microwave energy is also transmitted through the reconfigurable shield.

In one example, the packaging material may be used in a microwave oven to control microwave heating of food. During a first phase of the microwave heating, the reconfigurable shield may be in the less transmissive configuration, so that at least a portion of the food is heated substantially only by evanescent microwave energy. During a subsequent or second phase of the microwave heating, the reconfigurable shield may be in the more transmissive configuration, so that at least the portion of the food is also heated by transmitted microwave energy.

During the microwave heating, the food may be positioned in the interior of a package that comprises the packaging material, and the volume of the interior of the package may remain substantially constant and/or may be vented to the ambient environment in the microwave oven. During the first phase of the microwave heating, the evanescent microwave energy may heat the exterior of the food in a manner so that the surface of the food is browned and/or crisped.

The packaging material may be configured so that the transition of the reconfigurable shield from the less transmissive configuration to the more transmissive configuration occurs at a predetermined time, e.g. after a certain desired degree of browning and/or crisping is achieved. The packaging material may be configured so that the transition of the reconfigurable shield from the less transmissive configuration to the more transmissive configuration occurs after a predetermined time delay. The predetermined time delay for the onset of the more transmissive configuration may be controlled by adjusting the design of the packaging material, such as by adjusting the speed at which the one or more closed cells inflate in response to exposure to microwave energy. The packaging material may be configured so that the predetermined time delay for the onset of the more transmissive configuration may be greater than about one minute, greater than about two minutes, greater than about three minutes, or any other suitable timeframe.

A package or packaging material may include one or more unshielded areas, and one or more reconfigurable shields. When a package or packaging material has multiple reconfigurable shields, the predetermined time delay for the onset of the more transmissive configuration may vary between the reconfigurable shields. In this regard, packaging materials and packages of this disclosure may be configured to tailor the manner in which food is microwave heated, so that different ratios between the evanescent microwave energy and transmitted microwave energy and/or different time delays for the onset of the more transmissive configuration may be associated with different portions of the food being microwave heated.

The foregoing presents a simplified summary of some aspects of this disclosure in order to provide a basic understanding. The foregoing summary is not an extensive summary of the disclosure and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Having described some aspects of this disclosure in general terms, reference will now be made to the accompanying drawings, which are schematic and not necessarily drawn to scale. The drawings are exemplary only, and should not be construed as limiting the invention.

FIG. 1A is an isolated, top plan view of a reconfigurable shield that may comprise part of packaging, in accordance with first and second embodiments of this disclosure.

FIG. 1B is an exploded, top perspective view of the reconfigurable shield of FIG. 1A, where the reconfigurable shield includes upper grid portions and lower grid portions.

FIG. 2A is an isolated, bottom perspective view of an upper laminate that includes upper grid portions, in accordance with the second embodiment.

FIG. 2B is a bottom perspective view showing an upper laminate, which includes the upper grid portions, exploded away from a portion of a lower laminate, which includes the lower grid portions, in accordance with the first embodiment.

FIG. 2C is similar to FIG. 2B, and further shows an additional substrate of the lower laminate.

FIG. 3A is a partially exploded, top perspective view of at least a portion of packaging material, in accordance with the first embodiment.

FIG. 3B is a top plan view of the portion of the packaging material of FIG. 3A in an assembled, less transmissive configuration.

FIG. 4A is a top perspective view of the portion of the packaging material of FIG. 3B, wherein a representative uninflated closed cell is schematically emphasized.

FIG. 4B is a top perspective view of an enlarged portion of the packaging material of

FIG. 4A in more transmissive configuration, where FIG. 4B schematically shows a representative inflated cell, in accordance with the first embodiment.

FIG. 5A schematically illustrates an arrangement of seal lines and connections between the upper and lower laminates of a packaging material, in accordance with a third embodiment of this disclosure.

FIG. 5B is a top perspective view of a portion of packaging material in a less transmissive configuration, in accordance with the third embodiment.

### DETAILED DESCRIPTION

Examples of embodiments are described below and illustrated in the accompanying drawings, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. For example, features illustrated or described as part of one embodiment can be used in the context of another embodiment to yield a further embodiment, and these further embodiments are within the scope of the present invention.

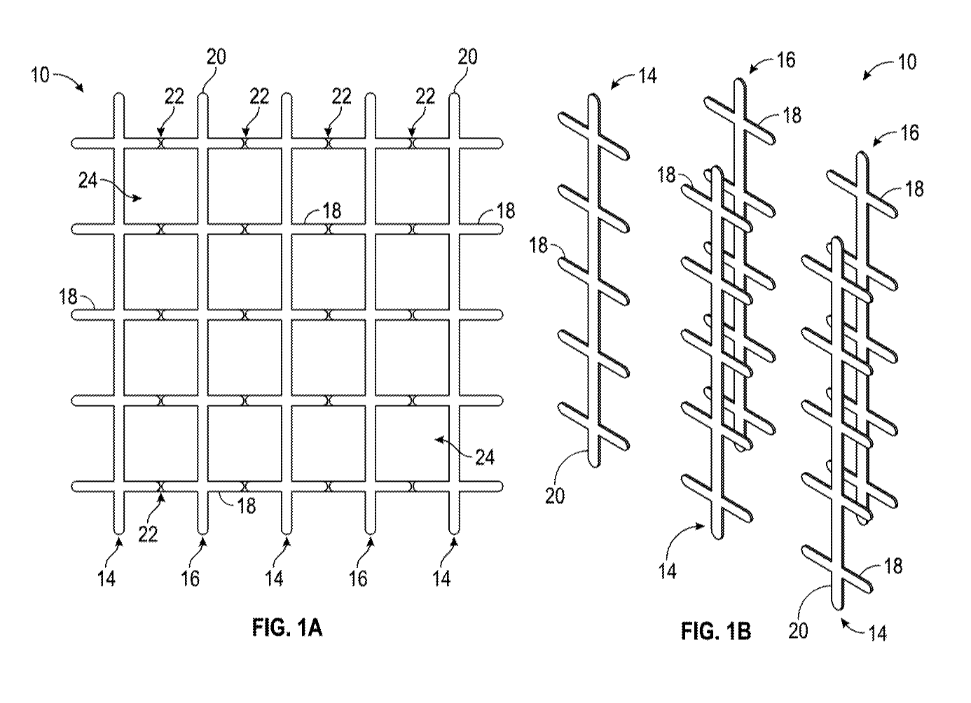

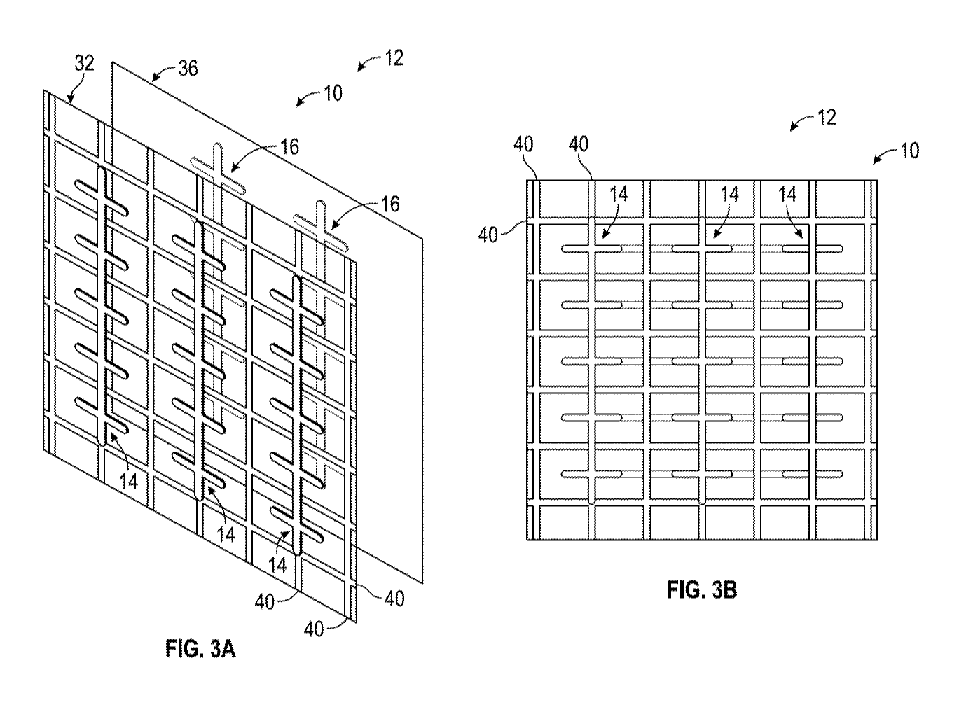

Referring in greater detail to the drawings, FIG. 1A illustrates a reconfigurable shield 10 comprising at least one pattern of shielding microwave interactive material (“shield material”), in accordance with first and second embodiment of this disclosure. The reconfigurable shield 10 may be part of packaging material 12 (FIGS. 3A-4A and 5B), and the packaging material may be formed into, or be part of, a package, such as a tray, carton, pouch or the like, configured for at least partially containing or otherwise being associated with food. As will also be discussed in greater detail below, the packaging material 12 may be configured so that, at a predetermined time during microwave heating of the food, the reconfigurable shield 10 automatically transitions from a first, relatively more effective shielding configuration (“less transmissive configuration”) to a subsequent, second, or less effective shielding configuration (“more transmissive configuration”), so that the packaging material varies, as a function of time, a ratio of microwave energy transmitted through the packaging material to the food. FIG. 1A shows the reconfigurable shield 10 in the less transmissive configuration. The packaging material 12 may be configured so that the microwave energy is automatically selectively transmitted in different ratios.

As apparent from FIGS. 1A and 1B, the reconfigurable shield 10 may comprise a grid pattern of the shield material. The grid pattern may be defined by portions or elements 14, 16 of the shield material (“shield elements”). The shield elements 14, 16 may be configured as portions of the grid pattern (“grid portions”) that are arranged in layers. An upper layer may include one or more (e.g., three) upper grid portions 14, and a lower layer may include one or more (e.g., two) lower grid portions 16. Each grid portion 14, 16 may include a series of arms 18 that are spaced apart from one another and extend outwardly from opposite sides of a central strip 20. For each grid portion 14, 16, the arms 18 and central strip 20 may be integrally formed with one another. In the first and second embodiments, the arms 18 and central strips 20 are formed from the shield material, and the shield material is a highly conductive material, such as a perfect electric conductor (PEC) (e.g. aluminum, copper, or any other suitable metal). In the first and second embodiments, the thickness of the shield material, which forms the grid portions 14, 16, is greater than the skin depth of microwaves at 2.45 GHz. For example, the shield material of the grid portions 14, 16 may have a thickness within a range of from about 0.1 μm to about 1 μm, a thickness within a range of from about 4 μm to about 10 μm, a thickness in a range of about 5 μm to about 10 μm, a thickness of about 7 μm, or any subranges therebetween. The thickness of the shield material, which forms the grid portions 14, 16, may be greater than the skin depth of microwaves at any other suitable frequency, such as, but not limited to, a frequency of 915 MHz.

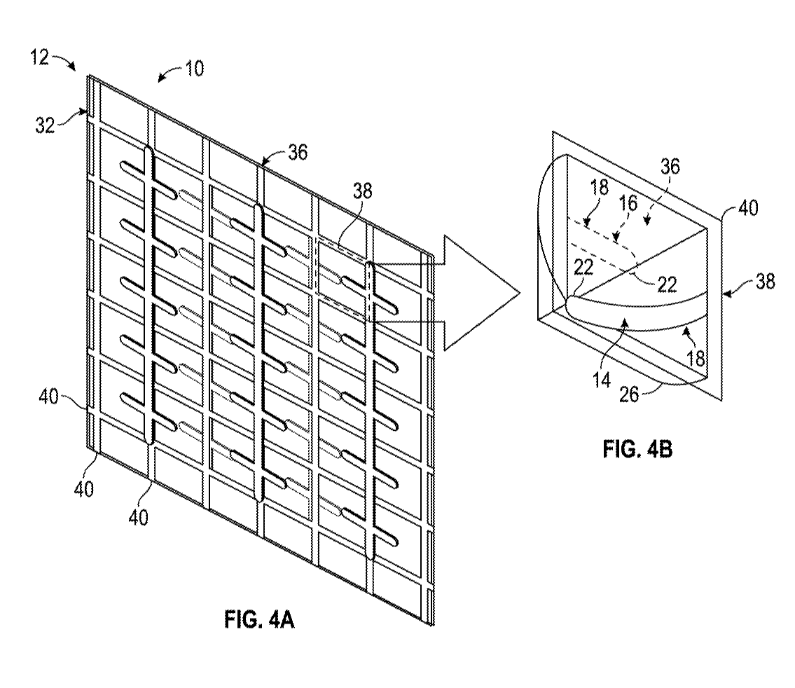

Tips of the arms 18 may be configured to cooperatively operate in pairs, wherein a gap of the reconfigurable shield 10 may be selectively defined between each tip pair 22 (e.g., see FIG. 4B), and the sizes of the gaps are adjustable (e.g., the gaps are openable, closable and/or substantially closable). With reference to FIG. 1A, the gap between each tip pair 22 is closed or substantially closed when the tips of the tip pair are in close proximity to one another. In contrast and referring to FIG. 4B, the gap between each tip pair 22 is relatively widely open when the tips of the tip pair 22 are relatively widely separated from one another. In the less transmissive configuration of the reconfigurable shield 10, all of, at least a majority of, or any other suitable number of the gaps between the tip pairs 22 of the reconfigurable shield are in their closed or substantially closed configurations. In contrast, in the more transmissive configuration, all of, at least a majority of, or any other suitable number of the gaps of the reconfigurable shield 10 are in their relatively wide open configurations.

Referring to FIG. 1A, when the reconfigurable shield 10 is in its less transmissive configuration, such as a result of all of its gaps between tip pairs 22 being closed or substantially closed, the reconfigurable shield defines a plurality of apertures 24 that extend therethrough. In the less transmissive configuration, the apertures 24 are sized so that transmitted microwave energy is not, or is substantially not, transmitted through the reconfigurable shield 10 while the reconfigurable shield is positioned in an operating microwave oven. Only or substantially only the evanescent microwave energy cooks the food while the reconfigurable shield is in its less transmissive configuration and positioned in an operating microwave oven. For example, in the top plan view of FIG. 1A, when the reconfigurable shield 10 is in its less transmissive configuration, each aperture 24 may have a crosswise dimension of less than about 1.25 cm.

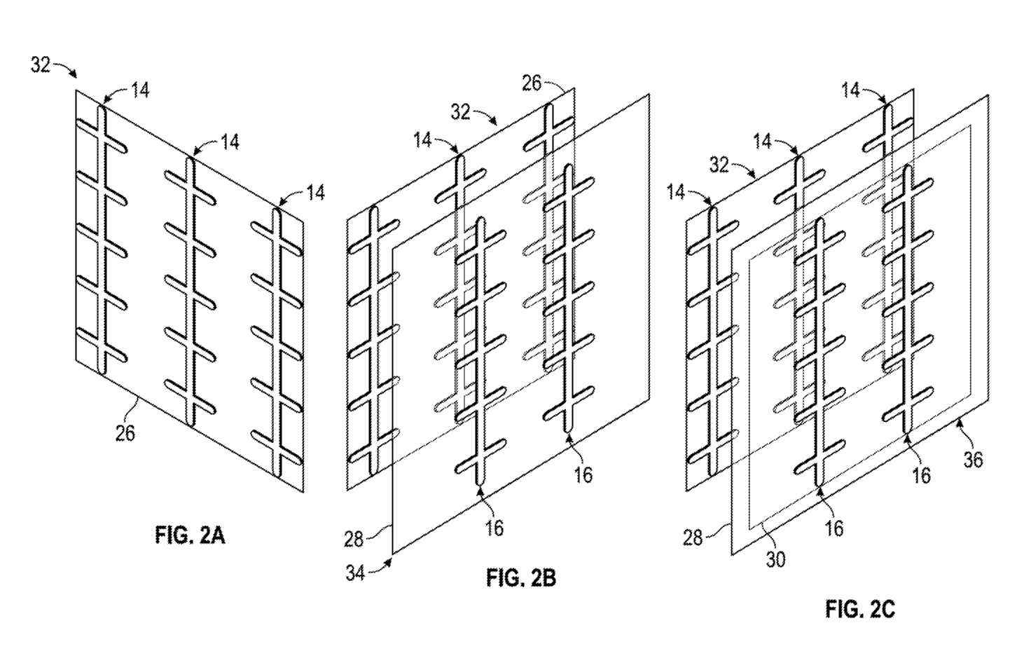

With reference to FIGS. 2A-2C, the packaging material 12 (FIGS. 3A-4A and 5B) includes upper, intermediate and lower substrates 26, 28, 30 that are transparent, or substantially transparent, to microwave energy and to which the grid portions 14, 16 are respectively mounted. FIG. 2A schematically illustrates an upper laminate 32 of the packaging material 12, in accordance with the second embodiment. The upper laminate 32 includes upper grid portions 14 mounted to upper substrate 26, where the upper grid portions may be mounted to the upper substrate in any suitable manner. For example, the upper substrate 26 may be a flexible polymeric film to which the upper grid portions 14 are attached with adhesive material, or the upper substrate may be a heat-sealable, flexible polymeric film to which the upper grid portions are thermally bonded, and/or the upper grid portions and the upper substrate may be associated with one another in any other suitable manner. For example, the upper grid portions 14 may be formed from a precursor foil, such as through an etching process or any other suitable separating process, or the like.

FIG. 2B is a bottom perspective view schematically illustrating the upper laminate 32 of the packaging material 12 and a precursor 34 to a lower laminate 36 (FIG. 2C) of the packaging material 12 in opposing face-to-face configuration with one another, in accordance with the first embodiment. As shown in FIG. 2B for the upper laminate 32 of the first embodiment, the upper grid portions 14 are mounted to the upper surface of the upper substrate 26. In contrast and as shown in FIG. 2A for the upper laminate 32 of the second embodiment, the upper grid portions 14 are mounted to the lower surface of the upper substrate 26.

As shown in FIG. 2B, the precursor laminate 34 may include the lower grid portions 16 mounted to the intermediate substrate 28, wherein the lower grid portions may be mounted to the intermediate substrate in any suitable manner. For example, the intermediate substrate 28 may be a moisture-containing layer, such as a thin fibrous (e.g., cellulosic) material with a predetermined moisture content (e.g. paper), and the lower grid portions 16 may be attached to the intermediate substrate with adhesive material or in any other suitable manner. For example, the lower grid portions 16 may be formed from a precursor foil, such as through an etching process or any other suitable separating process, or the like.

FIG. 2C is a bottom perspective view that schematically illustrates the upper and lower laminates 32, 36 in a spaced apart, opposing face-to-face configuration with one another. As shown in FIG. 2C, the lower laminate 36 further includes the lower substrate 30, wherein the lower substrate, lower grid portions 16 and intermediate substrate 28 may be laminated together in any suitable manner. For example, the lower substrate 30 may be a flexible polymeric film that is laminated to the precursor laminate 34 with a flood coat of adhesive material, or the lower substrate 30 may be a heat-sealable, flexible polymeric film that is laminated to the precursor laminate 34 by way of thermal bonding, and/or the components of the lower laminate 36 may be associated with one another in any other suitable manner. The upper and lower substrates 26, 30 (e.g., polymeric films) may be visually transparent, translucent or opaque, and are typically transparent to microwave energy.

The upper grid portions 14 may be positioned between the upper substrate 26 and the lower laminate 36, or the upper substrate may be positioned between the upper grid portions and the lower laminate. For example and in accordance with the first embodiment; the upper substrate 26 (e.g., flexible film) is positioned between the upper grid portions 14 and the intermediate substrate 28 (e.g., fibrous material), and the lower grid portions 16 are positioned between the intermediate substrate 28 and the lower substrate 30 (e.g., flexible film). In the first embodiment, the upper substrate 26 is positioned between the upper grid portions 14 and the lower laminate 36 so that the upper substrate can increase the amount of dielectric insulation between the upper and lower grid portions 14, 16 in a manner that seeks to prevent arcing between the upper and lower grid portions. In contrast, in the second embodiment, the upper grid portions 14 are positioned between the upper substrate 26 (e.g., flexible film) and the intermediate substrate 28 (e.g., fibrous material), and the lower grid portions 16 are positioned between the intermediate substrate and the lower substrate 30 (e.g., flexible film).

In the first and second embodiments, the upper and lower laminates 32, 36 are laminated or otherwise connected to one another in a predetermined pattern to define a plurality of closed cells 38 (FIGS. 4A and 4B) between the upper and lower laminates. A representative closed cell 38 is called out in FIGS. 4A and 4B. Referring to FIGS. 3A and 3B, the connections between the upper and lower laminates 32, 36 may in the form of a predetermined pattern of microwave transparent seal lines 40. The seal lines 40 may be defined by adhesive material, heat seals, and/or in any other suitable manner.

In the first embodiment, the seal lines 40 are positioned between, and connect, the upper and intermediate substrates 26, 28 to one another, so that the closed cells 38 comprise the seal lines 40 and the upper and intermediate substrates. In the first embodiment, some of the seal lines 40 are respectively superposed with the central strips 20 of the grid portions 14, 16. Also in the first embodiment, the seal lines 40 respectively circumscribe the closed cells 38 in a manner such that, in plan views of the packaging material 12, the crosswise dimensions of the closed cells 38 are about the same as the crosswise dimensions of the apertures 24 of the reconfigurable shield 10, and the apertures 24 and closed cells 38 are in an offset arrangement with respect to one another so that the gaps between tip pairs 22 are respectively approximately centered in the closed cells.

The thickness of the upper and intermediate substrates 26, 28 may be very nominal such that, when the closed cells 38 are in their uninflated configurations such that the packaging material 12 is in its less transmissive configuration, the gaps between tip pairs 22 are substantially completely closed (e.g., any distance between the tips of each tip pair is so small that, with regard to the transmission of microwave energy through the reconfigurable shield 10, each tip pair substantially functions as a closed electrical contact, or the like).

In the foregoing description, features of packaging material 12 are described in a specific orientation for ease of understanding but not for the purpose of limiting the scope of this disclosure. For example, the packaging material 12 may be inverted or used in any other suitable orientation, the packaging material may include one or more additional layers, and the layers may be arranged in any suitable order. The packaging material 12 may be formed into, or be part of, a package, such as a tray, carton, pouch or the like, configured for at least partially containing or otherwise being associated with food. For example, the packaging material 12 representatively shown in FIG. 3A may be formed into a flexible pouch or included in one or more walls or panels of a substantially rigid package (e.g. a substantially rigid tray or a folding carton).

Examples of methods of using the packaging material 12 are discussed in the following, in accordance with the first and second embodiments of this disclosure. In accordance with an example of a method of using the packaging material 12, the packaging material and food are typically arranged so that the lower laminate 36 is positioned between the upper laminate 32 and the food, and the lower laminate is proximate, close to, or in intimate contact with the food being heated in the microwave oven. Accordingly, the lower laminate 36 may be referred to as an inner laminate 36, and the upper laminate 32 may be referred to as an outer laminate 32.

When the packaging material 12 is formed into a package that is more specifically in the form of a pouch, the inner laminate 36 may extend around and define the food-containing, interior space of the pouch, so that the inner laminate is proximate, close to, or in intimate contact with the food in the interior space of the pouch. The pouch may include one or more vents configured to vent the interior space of the pouch to the ambient atmosphere within the microwave oven. The vent(s) may be configured to prevent steam buildup within the interior space of the pouch, such as for restricting any lessening of contact between the inner laminate 36 and the exterior surface of the food being microwave heated. For relatively or substantially rigid packaging, the packaging material 12 may define or be integrated into an outer wall or panel of the package, a lid (e.g., film lid) of the package (e.g., tray), or the like, and the interior space of the package will typically be vented to the ambient atmosphere within the microwave oven (e.g., if rigid packaging is lidded, it may be vented by a slit in the lid).

While the food in the interior space of the package is heated in the microwave oven, the reconfigurable shield 10 is initially in its less transmissive configuration, so that at least a portion of the food is heated substantially only by evanescent microwave energy. During a subsequent or second phase of the microwave heating, the reconfigurable shield 10 may be in its transmissive configuration, so that at least the portion of the food is also heated by transmitted microwave energy. During the microwave heating of the food in the interior space of the package, the volume of the interior space of the package may remain substantially constant, for example at least partially as a result of the interior of the package being vented to the ambient environment in the microwave oven.

During the first phase of the microwave heating, due to the selected size of the apertures 24 and the gaps between tip pairs 22 being substantially closed, any heating of the food by transmitted microwave energy may be substantially restricted, so that the evanescent field energy heats the exterior of the food in a manner so that the surface of the food is browned and/or crisped. That is, during the first phase of microwave heating, substantially only the surface of the food is heated, which favors a Maillard reaction and caramelization for browning, and also favors crisping due to the package being vented. In this regard, the first phase of the microwave heating can mimic selected conditions in a conventional oven (i.e. conductive heating and convective drying at the surface). For example, when the food being microwave heated is bread, browning of the surface of the bread may occur due to the Maillard reaction between reducing sugar and: (1) amino acid or (2) protein or (3) any nitrogen containing compound, and caramelization of complex sugar. Crisping, on the other hand, may result from moisture migration away from the surface of the bread (convective drying), which may be at least partially facilitated by the above-discussed venting.

Also during the first phase of the microwave heating, the at least generally or substantially microwave energy transparent fibrous material of the intermediate substrate 28 is microwave heated in a gradual manner because: (1) the relatively thin thickness of the intermediate substrate 28 is not favorable to volumetric heating, (2) the dielectric property of the intermediate substrate is relatively lossless as compared to food, and (3) the inner substrate 30 (e.g., flexible film) of the inner laminate 36 functions as insulation for restricting conductive heat transfer between the food and the fibrous material of the intermediate substrate 28.

At a predetermined time, the gradual accumulation of heat in the fibrous material of the intermediate substrate 28 will reach a high enough level so that steam is produced from the moisture contained by the fibrous material of the intermediate substrate 28. Referring to FIG. 4B, wherein the upper substrate 26 is shown as being generally visually transparent, the evolution of steam from the fibrous material of the intermediate substrate 28 creates pressure within the closed cells 38 so that they inflate. Inflation of the closed cells 38 causes the gaps between tip pair 22 to become more widely separated, since the grid arms 18 are respectively mounted to (e.g., carried by) the upper and intermediate substrates 26, 28 that at least partially define opposite walls of the closed cells.

When the gaps between tip pairs 22 initially become sufficiently widely separated, for example as shown in FIG. 4B, the reconfigurable shield 10 is no longer in its less transmissive configuration, because it has transitioned to its more transmissive configuration so that the second phase of the microwave heating commences. During the second phase of microwave heating, the effective size of the apertures 24 has been sufficiently increased by the enlargement of the gaps between tip pairs 22, so that the food may be simultaneously heated by both evanescent microwave energy and transmitted microwave energy. The microwave heating during the second phase may not adversely affect any browning and/or crisping from the first phase because a crisp crust may have already be well developed before any moisture migration associated with the bulk heating of food from the transmitted microwave energy during the second phase.

After browning and/or crisping of the outer surface of the food during the first phase of microwave heating (e.g., by the evanescent microwave energy while the reconfigurable shield 10 is in its less transmissive configuration), the surface of the food may become substantially lossless. In this regard, the surface of the food may become substantially lossless as a result of the loss of moisture proximate the surface during the browning and/or crisping. The reduction in surface moisture may allow for better penetration of the transmitted microwave energy into the bulk of the food during the second phase of microwave heating (e.g., by the transmissive microwave energy while the reconfigurable shield 10 is in its more transmissive configuration).

The packaging material 12 may be configured so that the transition of the reconfigurable shield 10 from the less transmissive configuration to the more transmissive configuration occurs at a predetermined time, after a certain desired degree of browning and/or crisping from the evanescent microwave energy is achieved. That is, the packaging material 12 may be configured so that the transition of the reconfigurable shield 10 from the less transmissive configuration to the more transmissive configuration occurs after a predetermined time delay. The predetermined time delay for the onset of the more transmissive configuration may be controlled by adjusting the design of the packaging material 12, such as by adjusting the speed at which the one or more closed cells 38 inflate in response to exposure to microwave energy. The packaging material 12 may be configured so that the predetermined time delay for the onset of the more transmissive configuration may be greater than about one minute, greater than about two minutes, greater than about three minutes, or any other suitable timeframe.

The predetermined time delay for the transition from the less transmissive configuration to the more transmissive configuration may be controlled, for example, by adjusting the thickness and/or moisture content of the fibrous material of the intermediate substrate 28, or associating one or more susceptors with the fibrous material of the intermediate substrate 28 (e.g., incorporating small islands of susceptor material in the fibrous material, wherein the predetermined time delay may be controlled by the area of the susceptor material), or replacing the fibrous material of the intermediate substrate 28 with a susceptor that may be associated with moisture, one or more water-providing reagents and/or one or more gas-providing reagents that are operative to inflate the closed cells 38 in response to being heated, or incorporating small vent apertures in the closed cells 38 to control (e.g., release some of) the pressure inside the closed cells, and/or reconfiguring the seal lines 40.

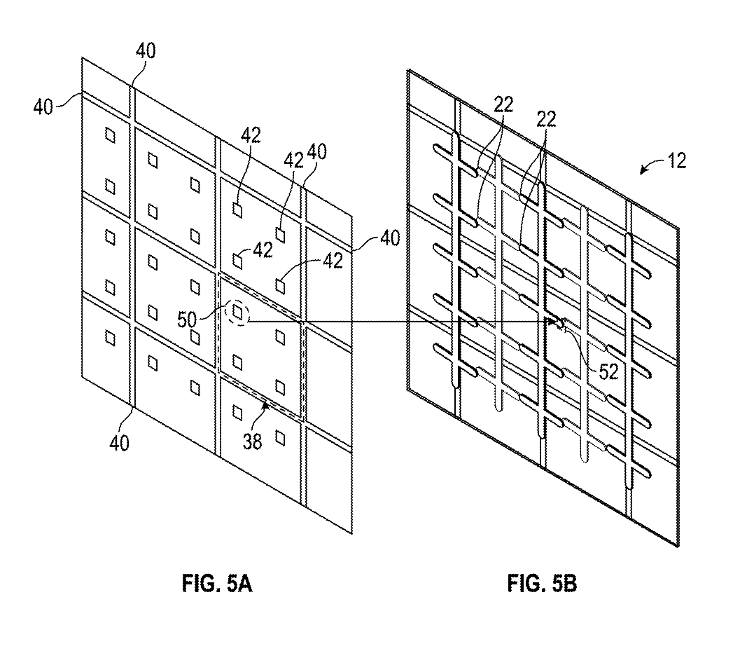

As an example of configuring the seal lines 40 differently than discussed above, FIGS. 5A and 5B illustrate features of a packaging material 12 of a third embodiment of this disclosure. In FIG. 5A, the square schematically represents the portions of seal lines 40 that define one closed cell 38 of the third embodiment, wherein an uninflated closed cell of the third embodiment is substantially the size of four uninflated closed cells of the first and second embodiments. In the third embodiment, four tip pairs 22 may be associated with each closed cell 38. As partially shown in FIG. 5A, for each tip pair 22, a connection 42, such as in the form of a small glued and/or heat sealed area, may be positioned between the tips (i.e., between the upper and lower laminates 32, 36), wherein a representative connection 42 is encircled at 50 in FIG. 5A. The location of the connection 42 encircled at 50 in FIG. 5A is identified in FIG. 5B by the tip 52.

As compared to the first and second embodiments, the closed cells 38 of the third embodiment are significantly larger. The closed cells 38 of the third embodiment require more steam for inflation and, thus, the predetermined time delay for the transition from the less transmissive configuration to the more transmissive configuration may be longer. In accordance with the third embodiment, when a certain pressure is reached in an uninflated closed cell 38, the relatively small connections 42 associated with that cell may instantaneously fail so that the gaps between the associated tip pairs 22 widen and the more transmissive configuration is achieved.

A package or packaging material may include one or more unshielded areas, and one or more reconfigurable shields 10. When a package or packaging material has multiple reconfigurable shields 10, or a reconfigurable shield with differently configured portions, the predetermined time delay for the onset of the more transmissive configuration may vary between the reconfigurable shields and/or potions of a reconfiguration shield, such as in an effort to overcome an uneven field distribution inside a microwave oven, such as by allowing for heating by only evanescent microwave energy in one or more areas while simultaneously there is heating by transmitted microwave energy in one or more other areas.

As discussed above regarding inflating the closed cells 38, alternatively or in addition to including the fibrous material of the intermediate substrate 28 and/or a susceptor, one or more water-providing reagents and/or one or more gas-providing reagents may be included in the packaging material and configured for at least partially inflating the closed cells after the predetermined time delay. For example, such a reagent may comprise sodium bicarbonate and a suitable acid, so that the heated reagents react to produce carbon dioxide. As another example, such a reagent may comprise a blowing agent. Examples of blowing agents that may be suitable include, but are not limited to, p-p′-oxybis(benzenesulphonyl hydrazide), azodicarbonamide, and p-toluenesulfonyl semicarbazide. As another example, a suitable packaging material 12 may comprise the reconfigurable shield 10 appropriately incorporated into QuiWave® brand packaging material available from Graphic Packaging International, Inc.

Regarding the above-discussed susceptor material or susceptors, a susceptor typically comprises a thin layer of microwave energy interactive material (e.g., a metal, such as aluminum, or a non-metal, such as indium tin oxide), generally less than about 500 angstroms in thickness, for example, from about 60 to about 100 angstroms in thickness, and having an optical density of from about 0.15 to about 0.35, for example, about 0.17 to about 0.28. When exposed to microwave energy, the susceptor tends to absorb at least a portion of the microwave energy and convert it to thermal energy (i.e., heat) through resistive losses in the layer of microwave energy interactive material. The remaining microwave energy is either reflected by or transmitted through the susceptor.

The above examples are in no way intended to limit the scope of the present invention.

It will be understood by those skilled in the art that while the present disclosure has been discussed above with reference to examples of embodiments, various additions, modifications and changes can be made thereto without departing from the spirit and scope of the invention.

What is claimed is:

1. A microwave energy shield that is reconfigurable between a first shielding configuration and a second shielding configuration, the shield comprises:
a pattern of shield material, the pattern of shield material comprises a first portion and a second portion that are positionable relative to each other,
the first portion of the pattern of shield material and the second portion of the pattern of shield material are positionable between a first position corresponding to the first shielding configuration and a second position corresponding to the second shielding configuration during microwave heating,
a first amount of microwave energy is reflected by the microwave energy shield in the first shielding configuration and a second amount of microwave energy is reflected by the microwave energy shield in the second shielding configuration, the first amount of microwave energy is different than the second amount of microwave energy.

2. The microwave energy shield of claim 1 wherein the first amount of microwave energy reflected by the microwave energy shield is more than the second amount of microwave energy reflected by the microwave energy shield.

3. The microwave energy shield of claim 1 wherein in the second shielding configuration, transmitted microwave energy passes through the microwave energy shield.

4. The microwave energy shield of claim 1 wherein the pattern of shield material comprises a grid pattern, the first portion is arranged in a first layer and the second portion is arranged in a second layer.

5. The microwave energy shield of claim 4 wherein the first layer is an upper layer and the second layer is a lower layer.

6. The microwave energy shield of claim 4 wherein the first portion is a first shield element comprising a first central portion and a plurality of first arms extending from the first central portion, the second portion is a second shield element comprising a second central portion and a plurality of second arms extending from the second central portion.

7. The microwave energy shield of claim 6 wherein the first plurality of arms each include a respective first tip of each first arm of the plurality of first arms and the second plurality of arms each include a respective second tip of each second arm of the plurality of second arms.

8. The microwave energy shield of claim 7 wherein the pattern of shield material comprises at least one first arm that is adjacent at least one second arm, the tip of the at least one first arm is spaced apart from the tip of the at least one second arm by a gap.

9. The microwave energy shield of claim 8, wherein in the first position of the pattern of shield material the gap has a first dimension and in the second position of the pattern of shield material the gap has a second dimension.

10. The microwave energy shield of claim 9 wherein the first dimension is less than the second dimension.

11. The microwave energy shield of claim 1 wherein, in the first shielding configuration, less microwave energy is transmitted through the microwave energy shield than in the second shielding configuration.

12. The microwave energy shield of claim 1 wherein, in the second shielding configuration, less evanescent microwave energy is reflected by the microwave energy shield than in the first shielding configuration.

13. A method of heating a package comprising:
obtaining a package having a microwave energy shield that is reconfigurable between a first shielding configuration and a second shielding configuration, the shield comprises: a pattern of shield material, the pattern of shield material comprises a first portion and a second portion that are positionable relative to each other, the first portion of the pattern of shield material and the second portion of the pattern of shield material are positionable between a first position corresponding to the first shielding configuration and a second position corresponding to the second shielding configuration during microwave heating, a first amount of microwave energy is reflected by the microwave energy shield in the first shielding configuration and a second amount of microwave energy is reflected by the microwave energy shield in the second shielding configuration, the first amount of microwave energy is different than the second amount of microwave energy;
applying microwave energy to the package;
the microwave energy positioning the first portion of the pattern of the shield material and the second portion of the pattern of shield material from a first position to a second position;
the first position corresponding to a first shield configuration of the microwave energy shield and the second position corresponding to a second shielding configuration of the microwave energy shield;
transmitting a second amount of microwave energy through the microwave energy shield in the second configuration.

14. The method of claim 13 wherein the first amount of microwave energy reflected by the microwave energy shield is more than the second amount of microwave energy reflected by the microwave energy shield. The method of claim 13 wherein, in the second shielding configuration, transmitted microwave energy passes through the microwave energy shield.

16. The method of claim 13 wherein the pattern of shield material comprises a grid pattern, the first portion is arranged in a first layer and the second portion is arranged in a second layer.

17. The method of claim 16 wherein the first layer is an upper layer and the second layer is a lower layer.

18. The method of claim 16 wherein the first portion is a first shield element comprising a first central portion and a plurality of first arms extending from the first central portion, the second portion is a second shield element comprising a second central portion and a plurality of second arms extending from the second central portion.

19. The method of claim 18 wherein the first plurality of arms each include a respective first tip of each first arm of the plurality of first arms and the second plurality of arms each include a respective second tip of each second arm of the plurality of second arms.

20. The method of claim 19 wherein the pattern of shield material comprises at least one first arm that is adjacent at least one second arm, the tip of the at least one first arm is spaced apart from the tip of the at least one second arm by a gap.

21. The method of claim 20 wherein in the first position of the pattern of shield material the gap has a first dimension and in the second position of the pattern of shield material the gap has a second dimension.

22. The method of claim 21 wherein the first dimension is less than the second dimension.

23. The method of claim 13 wherein, in the first shielding configuration, less microwave energy is transmitted through the microwave energy shield than in the second shielding configuration.

24. The method of claim 13 wherein, in the second shielding configuration, less evanescent microwave energy is reflected by the microwave energy shield than in the first shielding configuration.

25. A packaging material for containing at least one food product, the packaging material comprises:
a microwave energy shield that is reconfigurable between a first shielding configuration and a second shielding configuration, the shield comprises:
a pattern of shield material, the pattern of shield material comprises a first portion and a second portion that are positionable relative to each other,
the first portion of the pattern of shield material and the second portion of the pattern of shield material are positionable between a first position corresponding to the first shielding configuration and a second position corresponding to the second shielding configuration during microwave heating,
a first amount of microwave energy is reflected by the microwave energy shield in the first shielding configuration and a second amount of microwave energy is reflected by the microwave energy shield in the second shielding configuration, the first amount of microwave energy is different than the second amount of microwave energy.

26. The packaging material of claim 25 wherein the first amount of microwave energy reflected by the microwave energy shield is more than the second amount of microwave energy reflected by the microwave energy shield.

27. The packaging material of claim 25 wherein, in the second shielding configuration, transmitted microwave energy passes through the microwave energy shield.

28. The packaging material of claim 25 wherein the pattern of shield material comprises a grid pattern, the first portion is arranged in a first layer and the second portion is arranged in a second layer.

29. The packaging material of claim 28 wherein the first layer is an upper layer and the second layer is a lower layer.

30. The packaging material of claim 28 wherein the first portion is a first shield element comprising a first central portion and a plurality of first arms extending from the first central portion, the second portion is a second shield element comprising a second central portion and a plurality of second arms extending from the second central portion.

31. The packaging material of claim 30 wherein the first plurality of arms each include a respective first tip of each first arm of the plurality of first arms and the second plurality of arms each include a respective second tip of each second arm of the plurality of second arms.

32. The packaging material of claim 31 wherein the pattern of shield material comprises at least one first arm that is adjacent at least one second arm, the tip of the at least one first arm is spaced apart from the tip of the at least one second arm by a gap.

33. The packaging material of claim 32, wherein in the first position of the pattern of shield material the gap has a first dimension and in the second position of the pattern of shield material the gap has a second dimension.

34. The packaging material of claim 33 wherein the first dimension is less than the second dimension.

35. The packaging material of claim 25 wherein, in the first shielding configuration, less microwave energy is transmitted through the microwave energy shield than in the second shielding configuration.

36. The packaging material of claim 25 wherein, in the second shielding configuration, less evanescent microwave energy is reflected by the microwave energy shield than in the first shielding configuration.

37. The packaging material of claim 25 further comprising a first layer of a grid pattern in a first layer of packaging material and a second layer of grid pattern in a second layer of packaging material.
